(19) United States
(12) Patent Application Publication
(10) Pub. No.: US 2023/0235119 A1
(43) Pub. Date: Jul. 27, 2023

(54) IMPROVED ALKOXYLATION PROCESS

(71) Applicant: ARKEMA FRANCE, COLOMBES (FR)

(72) Inventors: Jean-Philippe GILLET, PIERRE-BENITE CEDEX (FR); Beatrice ALLARD-BRETON, PIERRE-BENITE CEDEX (FR); Stephanie BRUEL, PIERRE-BENITE CEDEX (FR)

(21) Appl. No.: 17/999,657

(22) PCT Filed: Jun. 29, 2021
(86) PCT No.: PCT/FR2021/051189

§ 371 Date: Nov. 22, 2022

(30) Foreign Application Priority Data
Jun. 30, 2020 (FR) FR2006854

(51) Int. Cl. C08G 65/10; C08K 5/42; B01J 23/04

(52) U.S. Cl. CPC C08G 65/10; B01J 23/04; C08K 5/42; C08G 2650/58

(57) ABSTRACT

The present invention relates to a method for preparing a fatty-chain high-molecular-weight alkoxylate, comprising treating the reaction medium with an acid having a pKₐ of 3.5 or less.

The present invention relates to an improved alkoxylation process, more particularly to a process for preparing alkoxylated compounds, in particular high molar mass alkoxylated compounds, and more particularly high molar mass alkoxylated compounds comprising a fatty chain.

Alkoxylated compounds (also referred to as alkoxylates in the remainder of the disclosure), and in particular fatty-chain alkoxylates, are compounds that are used ever more frequently in particular as additives, adjuvants, chemical intermediates, and surfactants (nonionic surfactants), and others, in various fields of applications, such as for example in the general chemical industry, in the pharmaceuticals, cosmetics, food-processing, phytosanitary and textile industries, in the cleaning, ore, fertilizer, petroleum and gas extraction, road construction, coating, adhesive, sealant, lubrication and paper industries, and others, to mention just the main fields of application.

For these fields of application, the alkoxylated compounds must generally and most often have high purities, that is to say contain the smallest possible amounts of impurities, and in particular of undesirable products, and more particularly those generated during the synthesis of said alkoxylated compounds.

The reaction of polymerization of alkylene oxides, by ring opening, under specific operating conditions, in particular in terms of nature of the catalysts used, reaction temperatures and pressures, have already been widely studied and industrialized on a large scale.

However, the synthesis of alkoxylated compounds, in particular high molecular weight alkoxylates and more particularly high molecular weight alkoxylates comprising a fatty chain, is often still delicate to carry out, in particular when the desire is to obtain high-purity products, that is to say those with the smallest possible amounts of by-products, with good production yields.

A few rare works mention the formation of impurities, such as for example in the patent EP1062263 B1, which teaches that the synthesis of propylene oxide polyether polyols, as well as polyurethane foams prepared from them, exhibit unpleasant odors and that the compounds responsible for these bad odors might be aldehydes, either as such or in latent form, and also cyclic ethers formed during the propoxylation reaction.

This patent also states that the elimination of the unpleasant odors is carried out by neutralization of the product of the propoxylation reaction with an acid of pKₐ of less than 5, at a temperature of between 80° C. and 130° C., and then by contact with water, at a temperature of between 80° C. and 130° C. The recovery of the final product, devoid of bad odors, comprises removal of the water and stripping of the propionaldehyde formed, or derivatives thereof.

There remains today a need for a process for preparing alkoxylated compounds, in particular high molar mass alkoxylated compounds, and more particularly high molar mass alkoxylated compounds comprising a fatty chain and satisfying the increasingly stringent purity criteria imposed by the industries that use such molecules, in particular as nonionic surfactants, synthesis intermediates, and others, as stated above.

Another objective is to propose a process for synthesizing alkoxylated compounds, in particular high molar mass alkoxylated compounds and more particularly high molar mass alkoxylated compounds comprising a fatty chain that are readily industrializable and advantageously that can be readily adapted to pre-existing techniques and installations used for the synthesis of such compounds.

It has now been discovered that the abovementioned objectives can be achieved, entirely or at least in part, by virtue of the present invention which will be described in more detail in the following description.

Thus, and according to a first aspect, the present invention relates to the process for preparing compounds of formula (1):

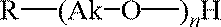

in which:
R represents a linear or branched hydrocarbon-based fatty chain comprising from 8 to 60 carbon atoms, optionally comprising one or more saturated or unsaturated rings, and possibly comprising one or more oxygen atoms,
Ak represents an alkylene unit with 2, 3 or 4 carbon atoms, preferably with 2 or 3 carbon atoms, and
n is an integer between 10 and 250, preferably between 15 and 200, more preferably between 18 and 160, limits included, said process comprising at least the following steps:

a) reacting a compound of the formula R-OH with at least one alkylene oxide, in the presence of a catalyst,
b) treating the reaction medium with an acid having a pKₐ of less than or equal to 3.5, and
c) recovering the compound of the formula R—(Ak—O—)ₙH by treatment of the thus-neutralized reaction medium.

As indicated above, within the meaning of the present invention, fatty chain R (present in the compound of formula (1) and in the compound of the formula R—OH) is understood to mean a hydrocarbon-based chain comprising from 8 to 60 carbon atoms, preferably from 8 to 40 carbon atoms, more preferably from 10 to 30 carbon atoms, limits included. This fatty chain R may comprise one or more saturated or partially or completely unsaturated rings, said chain may also be saturated or comprise one or more unsaturations, most often in the form of double bonds, triple bonds, or combinations of these unsaturations. This fatty chain may be linear or branched and may comprise one or more oxygen atoms, for example in the form of ether, alcohol, acid or ester functions, and also combinations of two or more of these oxygen-bearing functions, to cite only the most common functions bearing at least one oxygen atom. The polyalkoxylated chains are not considered to be fatty chains within the meaning of the present invention, but the fatty chains R within the meaning of the invention may themselves comprise one or more polyalkoxylated chains.

The compound of the formula R-OH, where R is as defined above, may be of any type well known to those skilled in the art and in particular may be chosen from fatty alcohols, fatty acids, fatty polyacids, alcohol esters, sugar esters, glycerides (mainly fatty mono- and diesters), fatty-chain phenol derivatives, but also polyols, such as sugars, alkyl polyglycosides, polyphenols, and also mixtures of two or more thereof, in any proportions. Very particular preference is given to implementing the process starting from compounds of the formula R—OH chosen from fatty alcohols, fatty acids, fatty polyacids, fatty-chain phenol derivatives, polyphenols, and also mixtures of two or more thereof, in any proportions, and more preferably from fatty alcohols, fatty acids and fatty-chain phenol derivatives, and also mixtures of two or more thereof, in any proportions.

As examples of compounds of the formula R—OH that may advantageously be used in the process of the present invention, mention may be made, in a nonlimiting manner, of octanoic (or caprylic) acid, nonanoic (or pelargonic) acid, decanoic (or capric) acid, undecanoic acid, undecylenic acid, dodecanoic (or lauric) acid, tetradecanoic (or myristic) acid, hexadecanoic (or palmitic) acid, octadecanoic (or stearic) acid, 9-octadecenoic (or oleic) acid, 9,12-octadecadienoic (or linoleic) acid, 9,12,15-octadecatrienoic (or linolenic) acid, arachidic acid, arachidonic acid, behenic acid, erucic acid, octanols (in particular 1-octanol), nonanols (in particular 1-nonanol), decanols (in particular 1-decanol), undecanols (in particular 1-undecanol), undecenols (in particular 1-undecenol), dodecanols (in particular 1-dodecanol), tetradecanols (in particular 1-tetradecanol), hexadecanols (in particular 1-hexadecanol), octadecanols (in particular 1-octadecanol), oleyl alcohol, sorbitol esters, sorbitan esters, sorbitol ethers, sorbitan ethers, isosorbide monoesters, isomannide monoesters, isoidide monoesters, isosorbide monoethers, isomannide monoethers, isoidide monoethers, hydroxyethyl oleate, cardanol, cardol, polyacids such as those sold under the Pripol name by Croda, tannins, lignans, lignins and other natural polyols or polyols derived from natural products, and also mixtures of two or more thereof in any proportions.

The alkylene oxide used in the process of the present invention may be of any type well known to those skilled in the art, and is advantageously chosen from ethylene oxide, propylene oxide and butylene oxide, and also mixtures thereof in any proportions, preferably from ethylene oxide and propylene oxide, and also mixtures thereof in any proportions, more preferably the alkylene oxide is ethylene oxide or propylene oxide, and advantageously the alkylene oxide is ethylene oxide.

The number “n” of (Ak—O—) units present in the compound of formula (1) is between 10 and 250, preferably between 15 and 200, more preferably between 18 and 160, limits included, as indicated above. In a very particularly preferred embodiment, the number “n” of (Ak—O—) units present in the compound of formula (1) is between 20 and 150, better still between 20 and 140, typically between 30 and 140, more specifically between 40 and 130, for example between 50 and 100, or else between 50 and 70, limits included. It should be understood that, when a plurality of different alkylene oxides make up the chain (Ak—O—)ₙ, these may be arranged randomly, in alternating fashion or else in blocks, as well as any combinations of these various arrangements.

The nature and the amount of catalyst used for the alkoxylation reaction may also vary within wide proportions, according to the alkoxylation techniques well known to those skilled in the art. Conventionally, the catalyst is generally a basic or alkaline catalyst, such as for example sodium hydroxide (NaOH) or potassium hydroxide (KOH). This is then referred to as sodium hydroxide catalysis or potassium hydroxide catalysis, respectively.

Other types of catalysts may also be used, and in particular those currently known to those skilled in the specialist art of alkoxylation under the name “narrow range” (narrow distribution) catalysts, and are for example chosen from catalysts based on calcium or based on boron-containing derivatives (for example of BF₃ type and derivatives), catalysts of hydrotalcite type, and catalysts of dimetallic cyanide (“double metal cyanide” or DMC) type.

DMC catalysts are for example described in the patents US6429342, US6977236 and PL398518. Among the known and commercially available catalysts, mention may be made of zinc hexacyanocobaltate with one or more ligands, for example the Arcol® catalyst sold by Covestro or else the MEO-DMC® catalyst sold by Mexeo.

According to one embodiment of the process of the present invention, the amount of catalyst used for the alkoxylation reaction ranges from 1 ppm to 10 000 ppm (by weight) relative to the amount of compound of the formula R—OH, preferably from 10 ppm to 10 000 ppm (by weight).

According to a preferred embodiment of the invention, the process employs basic catalysis and the catalyst used is a basic or alkaline catalyst, advantageously sodium hydroxide (NaOH) or potassium hydroxide (KOH), or else sodium or potassium alkoxides, more advantageously sodium hydroxide or potassium hydroxide, most frequently potassium hydroxide. In the case of a process carried out by basic catalysis, it may be advantageous, at the end of the alkoxylation reaction, to neutralize the reaction medium by adding an acid, generally a weak organic acid, for example chosen from formic acid, acetic acid and lactic acid, according to the conventional techniques well known to those skilled in the art.

However, it has been observed that the synthesis of high molar mass alkoxylates from a fatty-chain compound leads most often to the formation of impurities which may prove difficult to remove and troublesome or even harmful in the fields of application in which the fatty-chain alkoxylates are used, especially when they are used as surfactants in the cosmetics and pharmaceutical fields.

Identified in particular among these formed impurities are unsaturated ethers, for example vinyl ethers, but also aldehydes, acetals, hemiacetals, and others, in trace form, most often a few tens of ppm by weight to a few thousands of ppm by weight. Such ethers prove difficult to remove from the reaction medium by conventional techniques. However, for the reasons mentioned above, it is necessary in the vast majority of cases to remove them.

A plausible explanation for the formation of these unsaturated ethers is that they are by-products obtained during alkoxylation reactions involving a high number of alkoxyl (AkO) units, by competition between the normal SN2 reaction and the parasitic E2 elimination reaction. Under normal conditions and for medium to low molecular weights, the elimination reaction remains minor. On the other hand, when the number of alkoxylate units is high, as is the case in the process of the present invention (n of between 10 and 250, limits included), the steric hindrance becomes greater and the proportion of elimination reaction, and hence of the formation of impurities of unsaturated ether type, increases.

The Applicant has now discovered, with this forming the subject matter of the present invention, that it is possible to remove these impurities to a very great proportion by applying steps b) and c) of the process of the invention, corresponding respectively to treatment with an acid of pKₐ of less than or equal to 3.5, and then recovery of the purified product by treatment of the neutralized reaction medium.

Without wishing to be bound by theory, this is because it has been observed that impurities of unsaturated ether type chemically react in acidic medium to result in molecules, such as aldehydes, acetals, hemiacetals and others, which can be removed much more easily from the reaction medium, as explained below. The applicant has also discovered, surprisingly, that only certain acids, and in particular acids of pKₐ of less than or equal to 3.5, enable both the chemical conversion of the unsaturated ether species generated during the synthesis of alkoxylates of formula (1), i.e. fatty-chain high molecular weight alkoxylates, without however degrading or otherwise chemically reacting with said alkoxylates of formula (1).

Treatment with an acid of pKₐ of less than or equal to 3.5 has proven to be particularly effective on the impurities generated during the preparation of compounds of formula (1), in particular ethoxylated or else ethoxylated and propoxylated compounds of formula (1).

Acids of pKₐ of less than or equal to 3.5 which may be used in step b) of the process of the present invention may be of any type known per se, organic or mineral acids, Brønsted acids or Lewis acids. However, preference is given to using Brønsted acids, proton-donating acids, having a pKₐ of less than or equal to 3.5, preferably of less than or equal to 3, more preferably of less than or equal to 2.5, more preferably of less than or equal to 2, i.e. strong proton-donating acids, also referred to as acids with labile hydrogen.

Among the acids very particularly suitable for the process of the present invention, mention may be made, in a nonlimiting manner, of hydrochloric, sulfuric, nitric, and phosphoric acids, but also sulfamic acid, para-toluenesulfonic acid, alkanesulfonic acids, and also mixtures of two or more thereof in any proportions.

It has been observed that acids having a pKₐ of greater than 3.5 do not enable a satisfactory chemical conversion of the impurities of unsaturated ether type generated during the preparation of the high molecular weight fatty-chain alkoxylates, in particular products of the ethoxylation or ethoxylation/propoxylation of high molecular weight fatty-chain compounds. Within the meaning of the present invention, “high molecular weight” is understood to mean a molecular weight, as measured by gel permeation chromatography (GPC) generally of between 500 g/mol⁻¹ and 20 000 g/mol⁻¹, preferably between 750 g/mol⁻¹ and 15 000 g/mol⁻¹, better still between 1000 g/mol⁻¹ and 15 000 g/mol⁻¹, more particularly between 1000 g/mol⁻¹ and 10 000 g/mol⁻¹.

It should be understood that, when the alkoxylation reaction is carried out under basic catalysis, it is possible to use the acid of pKₐ of less than or equal to 3.5 both as acid making it possible to neutralize the basic catalyst and as acid making it possible to convert the undesirable impurities into compounds that are more easily removable from the reaction medium. It may, however, be advantageous for reasons of costs and convenience of the industrial process to proceed with a first acidification, under conventional conditions known to those skilled in the art, in order to neutralize the reaction medium and any basic catalyst residue, and then a second acidification with an acid of pKₐ of less than or equal to 3.5, in order to chemically convert the undesired impurities, as indicated above.

Thus, when it is desirable to neutralize the basic alkoxylation catalyst, the process of the present invention also comprises a step a2) between step a) and step b), said step a2) comprising the addition of an acid to the crude reaction medium obtained from step a). The acid used for step a2) may be any type of acid well known to those skilled in the art, whether strong or weak, organic or mineral, or else the acid used in step b) as will be explained below.

For the needs of step b) of treating the optionally neutralized reaction medium of the process according to the present invention, preference is given to using acids of pKₐ of less than or equal to 3.5 which are perfectly miscible in the reaction medium, that is to say barely capable, or not capable, of forming a separate phase in the reaction medium. In addition, the preferred acids of pKₐ of less than or equal to 3.5 are those having the smallest possible environmental impact.

Thus, a family of acids that is a very particularly suitable for the process according to the present invention consists of the alkanesulfonic acids. In the present invention, the term “alkanesulfonic acid” is preferentially understood to mean the alkanesulfonic acids of the formula Rₐ—SO₃H, where Rₐ represents a saturated, linear or branched hydrocarbon-based chain comprising from 1 to 4 carbon atoms.

The preferred alkanesulfonic acids for use in the context of the present invention are chosen from methanesulfonic acid, ethanesulfonic acid, n-propanesulfonic acid, isopropanesulfonic acid, n-butanesulfonic acid, isobutanesulfonic acid, sec-butanesulfonic acid, tert-butanesulfonic acid, and mixtures of two or more thereof in any proportions.

According to a preferred embodiment, the alkanesulfonic acid used in the context of the present invention is methanesulfonic acid or ethanesulfonic acid; entirely preferably, the acid used is methanesulfonic acid.

Thus, the process according to the present invention employs, in step b) of treating the reaction medium, at least one alkanesulfonic acid chosen from alkanesulfonic acids comprising a linear or branched chain comprising from 1 to 4 carbon atoms, and preferably at least methanesulfonic acid (more commonly denoted by its acronym MSA).

Said at least one alkanesulfonic acid that may be used in the process of the present invention may be used as it is, or in combination with one or more other components, that is to say in a formulation. Any type of formulation comprising at least one alkanesulfonic acid may be suitable. As a general rule, the formulation comprises from 0.01% to 100% by weight of alkanesulfonic acid, more generally from 0.05% to 90% by weight, in particular from 0.5% to 75% by weight, limits included, of alkanesulfonic acid(s), relative to the total weight of said formulation. It is for example possible to use formulations comprising from 0.01% to 40% by weight of alkanesulfonic acid, better still from 0.05% to 30% by weight, more specifically from 0.5% to 20% by weight, limits included, of alkanesulfonic acid(s), relative to the total weight of said formulation.

The formulation is for example an aqueous, organic or else aqueous-organic formulation. The formulation may be prepared in the form of a concentrated mixture, said concentrated mixture possibly being diluted by the final user. As a variant, the formulation may also be a ready-to-use formulation, that is to say that it does not need to be diluted. Finally, within the meaning of the present invention, the formulation may be a pure alkanesulfonic acid, or else a mixture of pure alkanesulfonic acids, that is to say that the formulation may contain only one or more sulfonic acids, without other formulation additive or other solvent or diluent.

The concentration of alkanesulfonic acid(s) in the formulation may vary within wide proportions. Those skilled in the art will know how to adjust the appropriate concentration of acid in the formulation without undue burden.

It is for example possible to use concentrated solutions, for example from 60% to 100%, preferably approximately 70% to 100%, by weight of alkanesulfonic acid(s), relative to the total weight of said formulation, or else less concentrated solutions of from 0.01% to 60%, preferably from 0.05% to 45%, advantageously from 0.1% to 40%, by weight of alkanesulfonic acid(s), relative to the total weight of said formulation.

According to a very particularly preferred aspect of the present invention, the acid of pKₐ of less than or equal to 3.5 used is methanesulfonic acid (pKₐ of -1.9). The methanesulfonic acid may advantageously be that sold in aqueous solution by Arkema under the name Scaleva®, or else under the name Lutropur® sold by BASF, ready to use or diluted in water in the proportions indicated above.

According to another aspect, the present invention relates to the use of an acid of pKₐ of less than or equal to 3.5, preferably of an alkanesulfonic acid, and more preferably of methanesulfonic acid, for the treatment of a reaction medium of the alkoxylation of a fatty-chain compound of the formula R—OH, where R is as defined above, and more particularly for the treatment of an alkoxylation reaction medium for the preparation of a compound of formula (1) as defined above.

Step b) of treatment with an acid of pKₐ of less than or equal to 3.5 may be carried out at various temperatures and pressures. For obvious reasons of convenience of the industrial process, preference is given to operation at atmospheric pressure. Likewise, the treatment temperature is advantageously between ambient temperature and 130° C., and more generally the treatment temperature is between 30° C. and 120° C., for example between 40° C. and 100° C.

The duration of treatment with the acid of pKₐ of less than or equal to 3.5 may also vary within wide proportions. The duration of contact with said acid is generally brief and is generally between a few minutes and a few hours, preferably between 5 minutes and 1 hour, for example approximately 30 minutes.

The amount of acid required may vary within wide proportions, but is generally between 4×10⁻³ and 0.1 mol per kg of reaction medium, preferably between 5×10⁻³ and 9×10⁻² mol per kg of reaction medium, better still between 6×10⁻³ and 8×10⁻² mol per kg of reaction medium.

As indicated above, the acid of pKₐ of less than or equal to 3.5 is a proton-donating acid and consequently requires the presence of a small amount of water which, if it is not present in the reaction medium or provided by the acid formulation, may advantageously be added to the reaction medium, for example during the acid treatment. This amount of water, already present or provided during the process of the invention, may vary within wide proportions and is generally between a few ppm by weight and a few % by weight, relative to the total weight of the reaction medium treated with the acid of pKₐ of less than 3.5.

Step c) of recovering the alkoxylation product consists in treating the neutralized reaction medium as has just been defined above, that is to say the reaction medium obtained from step b) treated with an acid having a pKₐ of less than or equal to 3.5. The treatment of step c) corresponds to the removal in full or at least to a very great extent, according to the conventional techniques well known to those skilled in the art, of the impurities chemically converted in step b) of the process of the invention.

Specifically, and as indicated above, by virtue of the acid treatment of the invention of step b) and as has just been defined, the chemically converted impurities are easily removed, in full or at least to a very great extent, according to the conventional techniques well known to those skilled in the art. Among these techniques, preference is given in particular to the techniques known as stripping, that is to say stripping with a stream of inert gas (in particular nitrogen), or preferably with steam, or else by distillation, optionally under reduced pressure, as well as combinations of two or more of these techniques. However, the method known as stripping, using inert gas or steam, and in particular steam, is preferred since it is already widely, and even commonly, used in industry.

Advantageously, step c) of recovering the compound of the formula R—(Ak—O—)ₙH does not comprise the additional addition of water and/or other solvent, nor the separation of solid particles (salts or other residues) formed during the alkoxylation process of the invention. Step c) of recovering the compound of the formula R—(Ak—O—)ₙH comprises the removal in full or at least to a very great extent of the compounds resulting from the acid treatment of the crude reaction mixture which comprised impurities generally responsible for the bad odors of the high molecular weight alkoxylated compounds, as defined above.

According to a very particularly preferred embodiment of the present invention, step c) of recovering the compound of formula (1) comprises, and preferably consists in, removing the products, formed during step b) of treatment with an acid of pKₐ of less than or equal to 3.5, by steam stripping. This operation is generally carried out at a temperature of between 50° C. and 150° C., for example between 70° C. and 125° C., at a pressure generally of between 5 kPa and atmospheric pressure (i.e. around 100 kPa), preferably between 5 kPa and 50 kPa, for a duration generally of between a few tens of minutes and a few hours, more generally between one hour and 7 hours. Operations, other than stripping, for removing the undesirable products formed during step b) can of course be envisaged, provided that they lead to the desired result without harming the purity and the quality of the synthesized alkoxylates, and while meeting the appropriate environmental and economic constraints.

The process of the present invention has a very great number of advantages, and very particularly in that it makes it possible on an industrial scale to simply and efficiently obtain high molecular weight fatty-chain alkoxylates having high degrees of purity, and in particular making it possible to meet increasingly stringent regulatory specifications, in particular in the fields of cosmetics and of human and animal health in general.

The process of the present invention is moreover simple to implement and economically inexpensive both in terms of operation and also of implementation. Specifically, the process of the present invention is easily adaptable to existing equipment, in that it requires only minor adaptations with respect to existing installations, in particular by addition of a system that makes it possible to treat the reaction medium with an acid of pKₐ of less than or equal to three and removal of the impurities including those formed during said acid treatment. The process of the present invention does not impair, or at the very least negligibly impairs, the overall synthesis process in terms of productivity.

The process of the present invention thus makes it possible to obtain high molecular weight fatty-chain alkoxylates, and in particular compounds of formula (1) as defined above, with very low levels of impurities. Specifically, by virtue of the treatment with the acid of pKₐ of less than 3.5, all of the species of unsaturated ether type are converted into chemical species (in particular aldehydes, hemiacetals and acetals as indicated above) which are easily removed by virtue of the treatment carried out in step c) of the process according to the present invention.

Thus, the high molecular weight fatty-chain alkoxylates obtained according to the process of the present invention most often exhibit an amount of impurities originating from the treatment with the acid of pKₐ of less than 3.5 of less than 500 ppm by weight, more generally of less than 300 ppm by weight and most often of less than 100 ppm by weight. In some cases, the process of the present invention made it possible to limit the presence of the impurities defined above to a value of less than 50 ppm, or even less than 10 ppm, indeed even less than 5 ppm.

The process of the present invention has been found to be quite effective for the preparation of the following fatty-chain high molecular weight alkoxylated, and in particular ethoxylated (OE), compounds:
C₁₆-C₁₈ alcohol with 33 OE,
C₁₀ oxo alcohol with 20 OE,
C₁₆-C₁₈ alcohol with 18 OE,
(C₁₈) oleyl alcohol with 20 OE,
stearic acid ethoxylated with 120 OE,
rapeseed oil with 20 OE,
rapeseed oil with 30 OE,
hydrogenated castor oil with 25 OE,
hydrogenated castor oil with 20 OE,
ester of sorbitan monolaurate with 20 OE,
ester of sorbitan monostearate with 20 OE,
ester of sorbitan monooleate with 20 OE,
coconut fatty acid with 150 OE.

The process of the invention thus enables the preparation, on the industrial scale, of compounds of interest that are fatty-chain high molecular weight alkoxylates, with high degrees of purity. It is thus possible to envisage the use of said high-purity alkoxylates as additives, chemical intermediates, surfactants, emulsifiers, demulsifiers, dispersants, detergents, compatibilizers, hydrotropic agents, wetting agents, agents for controlling the accumulation of electrostatic charges, foaming control agents, hydrophobicizing agents, flotation collectors, rheology control agents, dissolution control agents, crystallization control agents, in a wide range of fields of application, among which mention may be made, by way of nonlimiting examples, of the general chemical industry, and more particularly but not exclusively in the elastomer, polyether, polyester, polyurethane, and polyether block amide industries, but also in the pharmaceuticals industry, cosmetics industry, cleaning industry, ore enrichment industry, fertilizer industry, gas and petroleum extraction industry, road construction industry, food-processing industry, phytosanitary industry, coatings industry, adhesives industry, sealants industry, textile industry, lubrication industry, papermaking industry, and others, to mention just the main fields of application.

The following examples serve to illustrate the present invention without however limiting the scope thereof, the scope of protection thereof being defined by the claims appended to the present description.

### EXAMPLES

### Example 1: Industrial Synthesis of Stearic Acid With 120 OE (According to the Invention)

An industrial reactor is charged with 287.5 kg (1000 mol) of stearic acid (Radiacid 0417 from Oleon). The acid is melted by heating to 80° C. 2.5 kg of potassium hydroxide (85% KOH, in the form of granules (prills)) are then added. The reaction medium is dried at 110° C. under 40 mmHg (or approximately 5.33 kPa). The reaction medium is then brought to 170° C. 50 kg of ethylene oxide are then introduced at this temperature. When the reaction has started (when a drop in autogenous pressure and a rise in temperature are observed), the introduction of ethylene oxide is continued up to a total of 5280 kg (120 000 mol).

Once the addition has ended, cooking is carried out bymaintenance at temperature for 30 minutes. The reaction medium is cooled to 105° C. and transferred into a posttreatment reactor. The catalyst is neutralized with 1.25 kg of 80% formic acid in water.

0.115% (6.25 kg) of 70% methanesulfonic acid (Arkema) and 0.115% (6.25 kg) of water are then added. The mixture is maintained at 90° C. for 30 minutes. Steam stripping is then carried out at 105-110° C. for 5 hours under reduced pressure of 100 mmHg (i.e. 13.33 kPa). The final product is drained. Impurities of unsaturated ether type are no longer detected, and the final content of acetaldehyde, measured by NMR, is 3 ppm by weight.

### Example 2: Effect of the Treatment With MSA (pKₐ = -1.9, Laboratory Test)

In this example, the procedure is as in example 1, for the preparation of 500 g of stearic acid with 120 OE, by reaction of stearic acid with ethylene oxide, and the reaction catalyst (potassium hydroxide). At the end of the reaction cooking is carried out and the catalyst is neutralized as stated in example 1 with formic acid.

The acid treatment for controlling the impurities present in the reaction medium is carried out, at 90° C. with stirring and nitrogen inertizing, with 0.115% of 70% MSA (0.58 g) (sold by Arkema) and 0.115% (0.58 g) of water. The mixture is maintained at 90° C. for 30 minutes. A sample analyzed by NMR indicates that the entirety of the impurities of unsaturated ether type have disappeared and that acetaldehyde has formed to a level of 1840 ppm. Nitrogen stripping is carried out at 90° C. for 90 minutes. The final analysis of the product by NMR gives a residual content of acetaldehyde of 230 ppm.

### Example 3: Comparative by Treatment With HCOOH (pKₐ = 3.75, Laboratory Test)

Example 2 above is repeated, replacing the MSA with 80% formic acid in aqueous solution (sold by Vivochem). The mixture is maintained at 90° C. for 30 minutes. A sample analyzed by NMR indicates that the entirety of the impurities of unsaturated ether type are intact and that no acetaldehyde has formed in this case.

As can therefore be seen, the treatment with a strong acid of pKₐ of less than 3.5 is important in order to be able to convert the impurities of ether type into aldehyde functions that are then easily removed by stripping.

### Example 4: Industrial Trial of Treatment With MSA

A new industrial trial is carried out, as in example 1, using MSA to neutralize the catalyst and to treat the impurities of unsaturated ether type. Thus, in an industrial reactor, a batch of 5440 kg of stearic acid with 120 OE is synthesized under the conditions presented in example 1. The total amount of methanesulfonic acid used to neutralize the catalyst and treat impurities of unsaturated ether type is 9.25 kg of 70% MSA, i.e. 0.175% and 0.115% (6.25 kg) of water. After the steam stripping operation at 105-110° C., for 5 hours under reduced pressure of 100 mm of mercury (i.e. 13.33 kPa), the final product is drained. Impurities of unsaturated ether type are no longer detected, and the final content of acetaldehyde, measured by NMR, is 2 ppm.

1-11. (canceled)

12. A process for preparing a compound of formula (I): 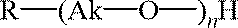
where:
R represents a linear or branched hydrocarbon-based fatty chain comprising from 8 to 60 carbon atoms;
Ak represents an alkylene unit with 2 carbon atoms, 3 carbon atoms, or 4 carbon atoms; and
n is an integer from 10 to 250;
the process comprising:
reacting a compound having formula R-OH, where R is as defined in formula (I), with at least one alkylene oxide, in the presence of a catalyst to produce a reaction medium;
treating the reaction medium with an acid having a pKₐ of less than or equal to 3.5 to produce a neutralized reaction medium; and
recovering the compound of formula (I) by treating the neutralized reaction medium.

13. The process of claim 12, wherein R of formula (I) and formula R-OH represents a linear or branched hydrocarbon-based fatty chain comprising from 8 to 60 carbon atoms, wherein the hydrocarbon-based fatty chain is saturated or unsaturated and optionally includes:
one or more saturated rings; or
one or more partially unsaturated rings; or
one or more completely unsaturated rings; or
one or more oxygen atoms in an ether functionality, an alcohol functionality, an acid functionality, or an ester functionality; or
any combination of these.

14. The process of claim 12, wherein R of formula (I) represents a linear or branched hydrocarbon-based fatty chain comprising from 8 to 40 carbon atoms, wherein the hydrocarbon-based fatty chain is saturated or unsaturated and optionally includes:
one or more saturated rings; or
one or more partially unsaturated rings; or
one or more completely unsaturated rings; or
one or more oxygen atoms in an ether functionality, an alcohol functionality, an acid functionality, or an ester functionality; or
any combination of these.

15. The process of claim 12, wherein R of formula (I) represents a linear or branched hydrocarbon-based fatty chain comprising from 10 to 30 carbon atoms, wherein the hydrocarbon-based fatty chain is saturated or unsaturated and optionally includes:
one or more saturated rings; or
one or more partially unsaturated rings; or
one or more completely unsaturated rings; or
one or more oxygen atoms in an ether functionality, an alcohol functionality, an acid functionality, or an ester functionality; or
any combination of these.

16. The process of claim 12, wherein n of formula (I) is an integer from 15 to 200.

17. The process of claim 12, wherein n of formula (I) is an integer from 18 to 160.

18. The process of claim 12, wherein the compound of the formula R-OH is selected from the group consisting of fatty alcohols, fatty acids, fatty polyacids, alcohol esters, sugar esters, glycerides, fatty-chain phenol derivatives, polyols, and combinations thereof.

19. The process of claim 18, wherein the polyols are selected from the group consisting of sugars, alkyl polyglycosides, polyphenols, and combinations thereof.

20. The process of claim 12, wherein the compound of the formula R-OH is selected from the group consisting of octanoic acid; nonanoic acid; decanoic acid; undecanoic acid; undecylenic acid; dodecanoic acid; tetradecanoic acid; hexadecanoic acid; octadecanoic acid; 9-octadecenoic acid; 9,12-octadecadienoic acid; 9,12,15-octadecatrienoic acid; arachidic acid; arachidonic acid; behenic acid; erucic acid; octanols; nonanols; decanols; undecanols; undecenols; dodecanols; tetradecanols; hexadecanols; octadecanols; oleyl alcohol; sorbitol esters; sorbitan esters; sorbitol ethers; sorbitan ethers; isosorbide monoesters; isomannide monoesters; isoidide monoesters; isosorbide monoethers; isomannide monoethers; isoidide monoethers; hydroxyethyl oleate; cardanol; polyacids; tannins; lignans; lignins and other natural polyols; polyols derived from natural products; and combinations thereof.

21. The process of claim 12, wherein the alkylene oxide is selected from the group consisting of ethylene oxide, propylene oxide, butylene oxide, and combinations thereof.

22. The process of claim 12, wherein the alkylene oxide is ethylene oxide.

23. The process of claim 12, wherein the catalyst is a basic or alkaline catalyst selected from the group consisting of sodium hydroxide, potassium hydroxide, sodium alkoxides, potassium alkoxides, and combinations thereof.

24. The process of claim 23, wherein the basic or alkaline catalyst comprises potassium hydroxide.

25. The process of claim 12, wherein the acid having a pKₐ of less than or equal to 3.5 is a mineral Brønsted acid, an organic Brønsted acid, a mineral Lewis acid, or an organic Lewis acid.

26. The process of claim 12, wherein the acid having a pKₐ of less than or equal to 3.5 is selected from the group consisting of hydrochloric acid, sulfuric acid, nitric acid, phosphoric acid, sulfamic acid, p-toluenesulfonic acid, alkanesulfonic acid, and combinations thereof.

27. The process of claim 12, wherein the acid having a pKₐ of less than or equal to 3.5 is selected from the group consisting of methanesulfonic acid, ethanesulfonic acid, n-propanesulfonic acid, isopropanesulfonic acid, n-butanesulfonic acid, isobutanesulfonic acid, sec-butanesulfonic acid, tert-butanesulfonic acid, and combinations thereof.

28. The process of claim 27, wherein the acid having a pKₐ of less than or equal to 3.5 is methanesulfonic acid.

29. The process of claim 12, wherein the compound of formula (I) is an alkoxylate selected from group consisting of:
C₁₆-C₁₈ alcohol with 33 OE;
C₁₀ oxo alcohol with 20 OE;
C₁₆-C₁₈ alcohol with 18 OE;
(C₁₈) oleyl alcohol with 20 OE;
stearic acid ethoxylated with 120 OE;
rapeseed oil with 20 OE;
rapeseed oil with 30 OE;
hydrogenated castor oil with 25 OE;
hydrogenated castor oil with 20 OE;
ester of sorbitan monolaurate with 20 OE;
ester of sorbitan monostearate with 20 OE;
ester of sorbitan monooleate with 20 OE; and
coconut fatty acid with 150 OE.
